(19) United States
(12) Patent Application Publication
(10) Pub. No.: US 2014/0229975 A1
(43) Pub. Date: Aug. 14, 2014

(54) Systems and Methods of Out of Band Application Synchronization Across Devices

(71) Applicant: COX COMMUNICATIONS, INC., Atlanta, GA (US)

(72) Inventors: Paul Bolden, Alpharetta, GA (US); James Alan Strothmann, Johns Creek, GA (US); Yousef Wasef Nijim, Roswell, GA (US); Jay Paul Langa, Cumming, GA (US)

(73) Assignee: COX COMMUNICATIONS, INC., Atlanta, GA (US)

(21) Appl. No.: 13/767,041

(22) Filed: Feb. 14, 2013

(51) Int. Cl. H04N 21/81

(52) U.S. Cl. CPC H04N 21/81
USPC 725/32

(57) ABSTRACT

The systems and methods of out of band application synchronization across devices disclosed herein include a companion application running on a secondary device, such as a mobile device. An out-of-band file containing program event markers is transmitted to a set top box. These program event markers may be used to link the program watched on the STB or the mobile device. Upon reaching the position indicated by the out-of-band file, the payload may be sent out by the STB to an application on a secondary device. The secondary device running the companion application receives the payload and triggers an action to fetch the associated metadata from the server. The companion application may include related content or advertisements, and communicate with a social network or the user's network to communicate at the same time with other customers watching the same program.

### TECHNICAL FIELD

The present disclosure is generally related to telecommunications services and, more particularly, is related to out of band application synchronization across devices.

### BACKGROUND

Content providers may add access for content users to additional content to enrich the experience of video programs offered by the content provider. For example, content providers that desire to present additional marketing and promotional content within original video programs can have the additional marketing content available on a secondary device such that particular icons, messages or interactive elements may be displayed to the user on that secondary device at particular parts of the video program.

The secondary device may display branded portions of video programs by displaying icons or related content during the broadcast of the video program. Thus, if a content provider wanted to promote an upcoming video program, an interactive icon can be displayed on the secondary device during the display of a commercial detailing an upcoming video program. While viewing the commercial, viewers can interact with the application on the secondary device.

In order for many of these additional features to work, the application on the secondary device must synchronize with the multimedia content stream in order to display the additional content data at the correct time. Typically, the additional content has been embedded directly into the multimedia content stream before the content is broadcasted. This way, the content access device processes the additional content along with the audio and video data within the multimedia content stream. By embedding the content directly into the multimedia content stream, the content provider is ensured that the additional data is presented to the user precisely where the content provider requested it to display. Further, the multimedia content stream may be embedded with additional information not visible to the user to assist the application in synchronization.

Previous solutions allow for DVRs and other multimedia devices to synchronize to in-band data within multimedia content streams. In-band data is used for signaling additional data over the same channel or “band” as the one used to send data, such as the audio and video data. One advantage of using in-band data for synchronization is that in-band data is normally left intact within content streams.

Examples of in-band data include closed-caption data and Enhanced Television (ETV) signaling data. When a multimedia device receives a multimedia content stream containing video programs and in-band data, the device processes the in-band data. The multimedia content stream may be broadcast over the air by a content provider or have been previously recorded by the multimedia device. During the recording or playback of the video programs, the multimedia device attempts to recognize in-band data patterns. The in-band data patterns may be provided from another device or service provider as event identification data. The event identification data identifies in-band data patterns that are associated with particular events in the multimedia content stream. The event identification data may be stored on a storage device and accessed when processing in-band data. There are heretofore unaddressed needs with previous in-band solutions.

### SUMMARY

Example embodiments of the present disclosure provide systems of out of band application synchronization. Briefly described, in architecture, one example embodiment of the system, among others, can be implemented as follows: a video display; memory configured to store an application; and a processor configured to run the application, the application configured to: receive a marker file on the secondary device that was transmitted from a provider out of band from the first frequency band; synchronize the marker file with the content viewed on the primary device; access secondary content when a marker from the marker file indicates that secondary content is applicable to the primary content viewed on the primary device; and display the secondary content on the video display.

Embodiments of the present disclosure can also be viewed as providing methods for out of band application synchronization across devices. In this regard, one embodiment of such a method, among others, can be broadly summarized by the following steps: receiving a marker file on the secondary device that was transmitted out of band from the first frequency band; synchronizing the marker file with the content viewed on the primary device; executing an application on the secondary device, the application configured to access secondary content when a marker from the marker file indicates that secondary content is applicable to the primary content viewed on the primary device; and displaying the applicable secondary content on the secondary device.

### BRIEF DESCRIPTION OF THE DRAWINGS

FIG. 1 is a system block diagram of an example embodiment of a system of out of band application synchronization across devices.

FIG. 2 is a block diagram of an example embodiment of a transport stream in the system of FIG. 1.

FIG. 3 is a flow diagram of an example embodiment of a method of out of band application synchronization across devices.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of out of band application synchronization across devices involve companion applications that run on secondary devices, such as a non-limiting example of a mobile device (for example, an iPads used while the user is watching content on a primary display device, such as a television).

Advanced versions of the companion applications employ Automatic Content Recognition (ACR) that recognize the content being played and/or the specific location within the content using audio fingerprinting or audio watermarks. Companion applications that exist outside of the cable infrastructure prevent MSOs from monetizing the interaction between the companion application and content provider. Example embodiments of the systems and methods of out of band application synchronization across devices facilitate ACR within the cable infrastructure, thereby providing revenue opportunities tied to MSO-bounded companion applications on a mobile device.

In an example embodiment, the MSO manages the creation, distribution, and processing of ACR markers in the system, allowing revenue opportunities with content providers, T-commerce, and other avenues. Since these markers are linked with the asset being viewed (program asset, commercial asset, or public service address (PSA), the application will link to the marker whenever the program is viewed. This includes linear streaming, video on demand (VOD), and digital video recorder (DVR) or any other linear or nonlinear media streaming.

Using a Personal Area Network (PAN, e.g. Bluetooth or Wi-Fi) allows for the user to be in front of the set top box (STB), securely linked to the MSO-issued STB, and entitled to the services being provided. The connection mechanism may include any STB-to-mobile connection mechanism. Implementation of this approach is possible via backend processes (except for the transmission of a trigger via STB) rather than through the normal video distribution network (in-band). This avoids a risk of the stripping of the in-band data by the headend or STB.

Most ACR technologies fall within two categories: “fingerprinting” and “watermarking”. Fingerprinting involves capturing an audio or video sample at a secondary application, and comparing the sample against a database of audio samples using backend servers. Although the audio samples may be accurate, they are susceptible to ambient noise and poor audio quality. Watermarking, although not as prevalent, involves placing key information inside the transport stream. This approach is often problematic in an MSO environment because the downstream processing of the video signal often strips out this key information.

In dynamic advertising insertion (DAI) technologies, advertisements are often marked in the VOD asset out-of-band such that the transport stream markers are stored in a separate file for processing. This approach is often favored over in-band approaches due to the problems previously mentioned about the potential downstream stripping of in-band metadata. In DAI, the transport stream is monitored for the marker(s) listed in the accompanying file. Upon identifying the markers, the monitoring system interrupts operations and inserts an advertisement.

In an example embodiment of the systems and methods of out of band application synchronization across devices, a companion application running on a mobile device has a wired/wireless internet connection, and/or Bluetooth capability. The secondary device may be paired to the STB either by the user downloading an application on the mobile device or the application may be pushed to the device if the user chooses to use the ACR capability from the STB. Example embodiments of the systems and methods of out of band application synchronization across devices disclosed herein identify the mobile devices that are in range with the STB. In an example embodiment, if the user has created a user name and password on an MSO account, then once the mobile device is identified, the application may be pushed to the mobile device and the customer may be asked to enter the user name and password created under the account. In an example embodiment, if the user downloads the application, the pairing will occur automatically when the two devices are in range.

In an example embodiment, the mobile device may be securely registered and linked to a STB within the home within a username/password-protected application providing authentication and authorization as created by the user. With the registration, the MSO may link the customer to the account through the cable modem or the STB. The mobile device may be connected to the back office through an Internet connection to push information from the back office or third party content provider linked to a companion application. In an example embodiment, an out-of-band file containing program event markers is transmitted to the STB (e.g. via EPG). The same file may be sent to the mobile devices as well if needed. These program markers may be used to link the program watched on the STB or the mobile device such as Program ID (including entertainment content, commercials, and PSA's), time-based positional markers, and a payload for transmitting to the STB, as well as additional metadata fields as set by the MSO to identify content. This information may be sent either encrypted through digital rights management (DRM) including advanced encryption standard (AES) or through a conditional access system. Upon reaching the precise position indicated by the out-of-band file, the payload may sent out by the STB via Bluetooth or Wi-Fi, for example, if the STB is connected through a home network. If the STB does not have Bluetooth or Internet capability, then the information may be sent/received to/from the mobile device through the back office.

In an example embodiment, the mobile device running the companion application receives the payload and triggers an action to fetch the associated metadata from the server. The companion application may include related content or advertisements, and communicate with a social network or the user's network to communicate at the same time with other customers watching the same program. The markers may be updated once the customer is watching the program from a DVR. In an example embodiment, when the STB notifies the back office that the user is streaming or watching content from the DVR, an updated marker file may be sent to the mobile device and/or the STB. In this manner, content providers may send freshened advertisements to the companion application as the user is watching DVR content.

So, in an example embodiment, application includes a synchronization feature such that the application is synchronized with what is being viewed on the television. The user should provide little to no input for the synchronization to be achieved. This technology is called Automatic Content Recognition, or ACR, which is often used to achieve the automatic synchronization. ACR may be achieved in a number of ways. Two common techniques are in-band and out-of-band synchronization. The in-band technique often uses markers or cue tones of some type that are either hidden in the media such that the device, such as a mobile device, can differentiate those and automatically sync with the timing of the transmitted program. In an example embodiment of the out-of-band technique, the audio that is being played is sampled and compared against a known database. In an example embodiment, not only is the program determined, but it also determines the timestamp within the program.

In a non-limiting example, when a character walks in with a special T-shirt in the program that is being viewed on the video presentation device, a pop-up ad may be sent to the secondary device, such as an iPad, to purchase that T-shirt. In an in-band technique transmission, anything that is passed through in that transmission band has the possibility of being filtered out of the transmission. The transmission stream is heavily processed once it is received, for example, by the set top box. However, with the out-of-band technique, the multiple system operator (MSO), for example, has little to no control over the stream and, in particular, the audio part of it. Therefore, attempting to monetize using the out-of-band data would be very difficult.

Out-of-band application synchronization overcomes these inadequacies by using marking technologies that are inserted by the MSO. These markers are, therefore, controlled by the MSO, as the markers are sent to the set top box. The set top box may then remove the out-of-band data from the transmission stream and send it to a secondary device by Wi-Fi or a secondary network, for example, for synchronization. The markers are used to fingerprint the audio so that the application on the secondary device synchronizes with the program on the primary device using the audio portion of the program. However, since the MSO has no input on the fingerprinting (because it is done before introduction into our system), it is not stripped out and it is likely to make it all of the way through with no ability to be monetized by the MSO.

Example embodiments of the disclosed out-of-band application synchronization utilizes the infrastructure of the service provider and utilizes the transmission that is already in place to send the synchronization information to the end user. The synchronization information may be sent to set top boxes, to smart televisions and to other devices. But as the MSO is controlling the transmission of the content to these devices, the MSO may control the water marks to conserve the timestamp within the transmission stream. In terms of the transmission stream, the transmission may be between the MSO and the set top box or a secondary device such as an iPhone, a smart phone, or other wired and wireless devices. The benefit for the MSO is that the MSO has the opportunity to monetize this in terms of advertisement fills, making assets specific to targeted users, and having flow control not only of the synchronization but also of the content of what the MSO sends out to the secondary devices.

In an example embodiment of the disclosed systems and methods of out-of-band application synchronization, rather than have the synchronization embedded in the stream with watermarking or some other indication in audio, The MSO may send out a separate file that has the markers or the program markers in this stream at this point. The file may direct the application on the secondary device to perform a routine. The file may be transmitted directly to the secondary device, or the file may be processed by the primary device, such as the set top box, and the primary device may send commands to the secondary device.

This marker information may be sent as a separate file and tracked along with the program that is being played. Prior to the act of the transmission being available, break points in the programs are identified and loaded into a marker file. In an example embodiment, insertions are added within the marker file so that the customer can choose the content he accesses. A customer may have the flexibility to select and use markers of a particular stream and have those markers synchronized to the content. In an example implementation, the set top box plays the Little Ding Hypothesis television show in its appropriate time slot and the marker file associated with the Little Ding Hypothesis is presented. The marker file is transmitted out of band, outside of the video stream. The marker file is processed and at least one marker is transmitted to a secondary device (such as a handheld device) to respond to it.

In an example embodiment, a user may desire more information or more interactions on something in a scene or related to something in that scene. The user may send an indication to the set top box, for example, to request additional markers. In an example embodiment, the primary markers are activated when the user opts in. The markers may be included in the meta data that is downloaded on each STB, but only activated upon the user opting in. Activation may also subscribe the secondary device to pop up events transmitted from the STB. If the user desires more interactions along that scene, the secondary device is synchronized to the marker file so that, for example, a pop-up comes up on the secondary device, such as a tablet, that presents information on an actor in that scene, for example. Information presented in the pop-up may include whether a search for that actor is stored on the DVR, or whether other programs with that actor is stored on the DVR, among other information. In an example embodiment, the application on the secondary device may be able to access DVR content that is already stored and a marker file is sent to the secondary device to be synchronized with that program.

In an example embodiment, if a user desires content, for example, on a particular person, product, or other content within a scene, the user can access other markers or perform a search for other markers that are considered to be related to that person, product, or other conduct. All markers may be centrally stored and tagged. Tag-based searches may be performed centrally with the results of the search transmitted to the secondary device. If, as a non-limiting example, a user wants a recommendation based on content associated with a particular actor in a scene, then the user may perform such a search based on the markers. The search may be performed on video on demand (VOD) content and/or cloud personalized content that is stored with the service provider. If the user wants to learn more about the content (movie) or extra material related to the content, an external database may be accessed based on the marker. In a non-limiting example, a web site (such as www.imdb.com) may be accessed. In another non-limiting example, an extra scene that may be available on the DVD release of the content may be accessed by the application on the secondary device by selecting a marker in the marker file. This extra content may be accessed on the secondary device such as a tablet while the original content is viewed on the primary device. In an example embodiment, the content on the primary device may be automatically paused when the extra content (particularly in the case of an associated video stream) is accessed on the secondary device.

In an alternative embodiment, trick play keys may be controlled based on the markers. For example, some markers may allow the pause and may disable the fast forward key. In general, though, general trick play keys such as fast forward, rewind, and pause are controlled by the markers such that a trick play of the content is performed on the primary screen when the trick play keys are applicable.

Since the marker file is sent out of band, the content is in complete control of the MSO and the functions of the application on the secondary device may be monetized. In an example embodiment, if the user doesn't want to be bothered by, for example, the pop-up advertisements, the user may set up the secondary device application to ignore the pop-up advertisements, while still responding to other content. Filters or rules may be setup so to manage the content response of the secondary device application. The screening or filtering may be performed automatically, or, for example, regardless of the content on the primary device, it may be the function of the owner to tag certain content to be filtered. In an example embodiment, the content is filtered by timestamp in the content rather than by items within the content. Content may also be filtered, for example, by title, actor, and genre, among others. The filtering may be automated as well as performed manually.

Another example implementation involves linear content such as sporting events. Inserting markers for real time content introduces challenges due to using a buffer to insert the markers. In an example embodiment, markers are inserted based on the type of content. For example, if the content is football, then markers are inserted based on the teams playing and on the type of sport so that the markers may be inserted in a timely fashion. Although there are some challenges (delays between the action taking place and the device information related to that action) to making it real time, a processing lag may be made acceptable for the user. Some delay may be allowable, but excessive delay will not lead to a good user experience. In an example implementation, the lag may be a second or two so that the markers are accessible is nearly real time. As processor and network speeds increase over time, that lag will decrease.

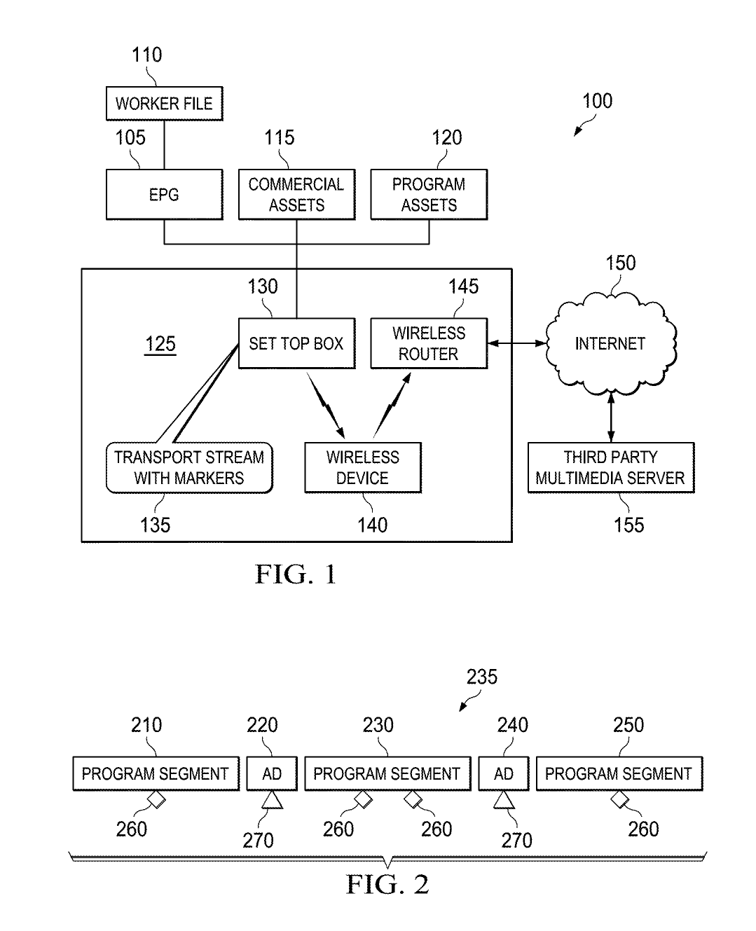

FIG. 1 provides a system block diagram of an example embodiment of a system of out of band application synchronization across devices 100. System 100 includes electronic program guide (EPG) 105, worker file 110, commercial assets 115, program assets 120, end user premises 125, Internet 150, and third party multimedia server 155. End user premises 125 may include set top box 130, which receives transport stream 135 with markers, wireless router 145, and wireless device 140. A program data stream including program assets 120 is sent to set top box 130 in a first frequency band by a content provider. In an example embodiment, commercial assets 115, such as advertisements, coupons, event announcements, additional products, and manufacturer information as non-limiting examples are sent embedded in or along with 120 program assets. Alternatively, commercial assets 115 may be transmitted separately in the first frequency band, or separately out of band, in a second frequency band. In an example embodiment, EPG 105 and worker file (also referred to as marker file) 110 are sent out of band from program assets 120. This allows for control and monetization by the MSO as described earlier.

At end user premises 125, transport stream 135, including primary content such as program assets 120 with embedded markers, is received by set top box 130. Set top box 130 displays the program assets 120 from transport stream 135. In an example embodiment, as program assets 120 are displayed, set top box 130 detects markers embedded in transport stream 135. Marker file 110 is sent to secondary device out of band from the first frequency band in which transport stream 135 is transmitted.

In an example embodiment, marker file 110 is sent to set top box 130 from the MSO. Marker file 110 is then sent from set top box 130 to secondary device 140, which, as a non-limiting example, may be a wireless device. In an example embodiment, marker file 110 is synchronized with program assets 120. This may be through matching the audio content of transport stream 135 and marker file 110. Other methods of synchronization include inaudible cues and video fingerprinting (through a mobile camera) for example. In an example embodiment, when set top box 130 detects a marker in transport stream 135, set top box 130 notifies the application on secondary device 140, which presents commercial assets 115 on a display of secondary device 140. In an alternative embodiment, secondary device 140 accesses Internet 150 through wireless router 145 (though a wired connection is also applicable) to access content on third party server 155. In an alternative embodiment, once synchronization between marker file 110 and transport stream 135 has been completed, the application on secondary device 140 may present the secondary content in marker file 110 without notification from set top box 130.

FIG. 2 provides an example embodiment of transport stream 235. Transport stream 235 includes program segments 210, 230, and 250, ads 220 and 240, program markers 260 and ad markers 270. When set top box 130 detects one of program markers 260, set top box 130 notifies the application on secondary device 140 that secondary content is to be displayed.

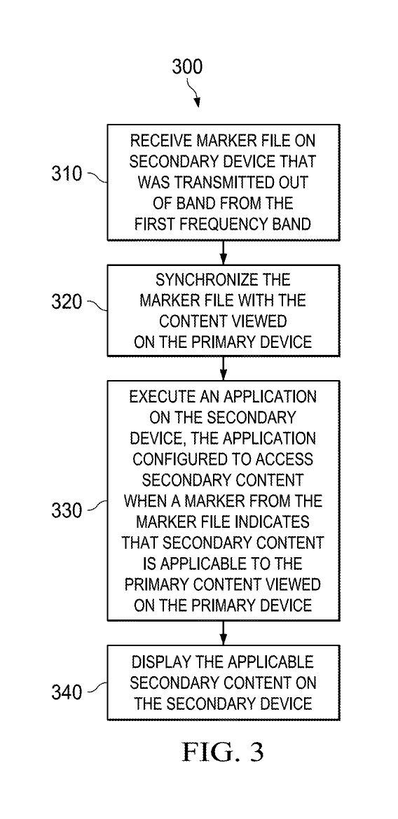

FIG. 3 provides flow chart 300 of an example embodiment of a method of out of band application synchronization across devices with a primary device receiving primary content on a first frequency band. In block 310, a secondary device receives a marker file that was transmitted out of band from a first frequency band. In block 320, the marker file is synchronized with content viewed on the primary device. In block 330, an application is executed on the secondary device. The application is configured to access secondary content when a marker from the marker file indicates that secondary content is applicable to the primary content viewed on the primary device. In block 340, the applicable secondary content is displayed on the second device.

The flow chart of FIG. 3 shows the architecture, functionality, and operation of a possible implementation of the digital isolation software. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

1. A method of synchronizing secondary content on a secondary device with primary content from a data stream received in a first frequency on a primary device, the method comprising:
receiving a marker file on the secondary device that was transmitted out of band from the first frequency band;
synchronizing the marker file with the content viewed on the primary device;
executing an application on the secondary device, the application configured to access secondary content when a marker from the marker file indicates that secondary content is applicable to the primary content viewed on the primary device; and
displaying the applicable secondary content on the secondary device.

2. The method of claim 1, wherein the marker file is received directly from a service provider.

3. The method of claim 1, wherein the marker file is received from a set top box, the set top box providing the primary content to the primary device.

4. The method of claim 1, wherein the marker file is received directly from a third party.

5. The method of claim 1, further comprising accessing content from the Internet, the content associated with the marker.

6. The method of claim 1, wherein the secondary content comprises an advertisement associated with the primary content.

7. The method of claim 1, further comprising filtering secondary content through the application.

8. The method of claim 1, further comprising searching for content stored on a digital video recorder through the application.

9. The method of claim 1, further comprising searching for content available through the primary device.

10. A system of synchronizing secondary content on a secondary device with primary content from a data stream received in a first frequency on a primary device, the system comprising:
a video display;
memory configured to store an application; and
a processor configured to run the application, the application configured to:
receive a marker file on the secondary device that was transmitted from a provider out of band from the first frequency band;
synchronize the marker file with the content viewed on the primary device;
access secondary content when a marker from the marker file indicates that secondary content is applicable to the primary content viewed on the primary device; and
display the secondary content on the video display.

11. The system of claim 10, wherein the marker file is received directly from a service provider.

12. The system of claim 10, wherein the marker file is received from a set top box, the set top box providing the primary content to the primary device.

13. The system of claim 11, wherein the processor accesses content from the Internet, the content associated with the marker.

14. The system of claim 11, wherein the secondary content comprises an advertisement associated with the primary content.

15. A non-transitory tangible computer readable medium comprising software, the software comprising instructions for synchronizing secondary content on a secondary device with primary content from a data stream received in a first frequency on a primary device, the instructions comprising:
receiving a marker file on the secondary device that was transmitted out of band from the first frequency band;
synchronizing the marker file with the content viewed on the primary device;
executing an application on the secondary device, the application configured to access secondary content when a marker from the marker file indicates that secondary content is applicable to the primary content viewed on the primary device; and
displaying the applicable secondary content on the secondary device.

16. The computer readable medium of claim 15, wherein the marker file is received directly from a service provider.

17. The computer readable medium of claim 15, wherein the marker file is received from a set top box, the set top box providing the primary content to the primary device.

18. The computer readable medium of claim 15, wherein the marker file is received directly from a third party.

19. The computer readable medium of claim 15, further comprising accessing content from the Internet, the content associated with the marker.

20. The computer readable medium of claim 15, wherein the secondary content comprises an advertisement associated with the primary content.
